(19) United States
(12) Patent Application Publication
(10) Pub. No.: US 2023/0222891 A1
(43) Pub. Date: Jul. 13, 2023

(54) DANGEROUS SITUATION MONITORING DEVICE IN SPACE BASED ON FREQUENCY RESPONSE PATTERN AND METHOD FOR MONITORING DANGEROUS SITUATION IN SPACE USING THE SAME

(71) Applicant: 1THEFULL PLATFORM LIMITED, Seoul (KR)

(72) Inventors: Seung-Yub KOO, Gyeonggi-do (KR); Seong-Taek HWANG, Gyeonggi-do (KR); Sung-Eon KONG, Seoul (KR); Jun-Hyoung KIM, Seoul (KR)

(21) Appl. No.: 18/070,590

(22) Filed: Nov. 29, 2022

(30) Foreign Application Priority Data
Jan. 11, 2022 (KR) 10-2022-0003796

(51) Int. Cl. G08B 25/01; G08B 25/00; G08B 17/12; G08B 13/196

(52) U.S. Cl. CPC G08B 25/014; G08B 25/009; G08B 17/125; G08B 13/19613

(57) ABSTRACT

A method for monitoring a dangerous situation in a space based on a frequency response pattern according to an embodiment includes loading, by a processing unit of a mobile terminal located in the arbitrary space, a setting value corresponding to an operational mode selected through control software installed on the mobile terminal, controlling, by the processing unit, a speaker of the mobile terminal to generate a frequency corresponding to the loaded setting value, receiving the frequency which was generated in the controlling and reflected in the space through a microphone of the mobile terminal, determining, by the processing unit, whether the dangerous situation occurred in the space by comparing the frequency response pattern with a preset reference value, and taking, by the processing unit, a follow-up action when it is determined that the dangerous situation occurred in the space by the determining.

### CROSS-REFERENCE TO RELATED APPLICATION AND CLAIM OF PRIORITY

This application claims the benefit under 35 USC §119 of Korean Patent Application No. 10-2022-0003796, filed on Jan. 11, 2022, in the Korea Intellectual Property Office, the entire disclosure of which is incorporated herein by reference for all purposes.

### BACKGROUND

### 1. Field

The present disclosure relates to a device for monitoring a dangerous situation in a space and a method for monitoring a dangerous situation in a space using the same, and more particularly, to a device for monitoring a dangerous situation in a space to accurately and rapidly recognize the dangerous situation in the space based on a frequency response pattern and take a follow-up action and a method for monitoring a dangerous situation in a space using the same.

### 2. Description of the Related Art

Recently, with the growing trend towards nuclear families, the number of people living in a house greatly decreases, and the number of double income households is increasing.

Besides, as the population is aging fast, the number of households in which one or two old people live is in a continuously increasing trend, and as a consequence, a wide variety of social issues are expanding.

Due to these social phenomena, compared to the past, as all the family members are absent from houses more frequently or a larger number of old people with limited mobility live alone, when dangerous situations such as intrusions and fires occur, it becomes difficult to effectively respond to the dangerous situations.

To deal with dangers, security systems for intruder monitoring and warning and fire alarm systems for smoke or heat detection and warning in the event of fires have been used to keep home safe, but it requires very high costs to construct the systems at home, and in many cases, the systems are managed by outsourcing companies, so costs continue to be incurred.

Accordingly, methods for solving these problems are required.

### SUMMARY

One or more embodiments of the present disclosure is designed to solve the above-described problem, and therefore one or more embodiments of the present disclosure are directed to providing a dangerous situation monitoring system which is constructed in an easy and convenient manner using a mobile terminal possessed by a user, and can detect a dangerous situation with high accuracy, making it possible to respond with the dangerous situation quickly.

The problems of the present disclosure are not limited to the above-described problems, and another problem will be clearly understood by those skilled in the art from the following description.

To achieve the above-described objective, a method for monitoring a dangerous situation in a space based on a frequency response pattern according to an embodiment of the present disclosure includes (a) loading, by a processing unit of a mobile terminal located in the arbitrary space, a setting value corresponding to an operational mode selected through control software installed on the mobile terminal, (b) controlling, by the processing unit, a speaker of the mobile terminal to generate a frequency corresponding to the loaded setting value, (c) receiving the frequency which was generated in the step (b) and reflected in the space through a microphone of the mobile terminal, (d) determining, by the processing unit, whether the dangerous situation occurred in the space by comparing the frequency response pattern with a preset reference value, and (e) taking, by the processing unit, a follow-up action when it is determined that the dangerous situation occurred in the space by the step (d).

In this instance, the method for monitoring a dangerous situation in a space based on a frequency response pattern may further include, before the step (a), (pre1) acquiring image data in the space through a camera of the mobile terminal, and (pre2) analyzing, by an image reader of the mobile terminal, the image data, and transmitting an operating command to the processing unit to perform the step (a) when an anomaly pattern is detected in the space.

Additionally, the operational mode may include a day mode having a day setting value special for day and a night mode having a night setting value special for night.

Here, the day setting value may be set to generate an inaudible frequency when a registered user is present in the space and an audible frequency when there is no registered user in the space, and the night setting value may be set to generate the inaudible frequency.

Additionally, the step (d) may include determining, by the processing unit, whether any one dangerous situation of an intrusion situation or a fire situation occurred by comparing the frequency response pattern with the preset reference value.

Accordingly, when the processing unit determines the intrusion situation in the step (d), the step (e) may include (e-1) acquiring image data in the space through the camera of the mobile terminal, (e-2) playing a preset audio question through the speaker, (e-3) changing to an intrusion non-alert situation when an input audio response to the audio question through the microphone is a registered user's voice, (e-4) changing to an intrusion alert situation when the input audio response to the audio question through the microphone is not the registered user's voice or there is no input audio response, and (e-5) transmitting the image data and an intrusion alert alarm to a preset external terminal after the change to the intrusion alert situation by the step (e-4).

Additionally, when the processing unit determines the fire situation in the step (d), the step (e) may include (e-6) acquiring image data in the space through the camera of the mobile terminal, (e-7) changing to a fire alert situation, and (e-8) transmitting the image data and a fire alert alarm to a preset external terminal after the change to the fire alert situation by the step (e-7).

Furthermore, to achieve the above-described objective, a device for monitoring a dangerous situation in a space based on a frequency response pattern according to an embodiment of the present disclosure includes a mobile terminal installed in the arbitrary space, and the mobile terminal includes a speaker to generate a frequency corresponding to an operational mode selected through control software installed on the mobile terminal, a microphone to receive the frequency which was generated by the speaker and reflected in the space, and a processing unit to load a setting value corresponding to the operational mode, determine whether the dangerous situation occurred in the space by comparing the frequency response pattern received by the microphone with a preset reference value, and take a follow-up action when it is determined that the dangerous situation occurred in the space.

Additionally, the mobile terminal may further include a camera to acquire image data in the space.

Additionally, an embodiment of the present disclosure may further include a holder unit to hold the mobile terminal.

In this instance, the holder unit may include a base part, a rotating part which rotatably operates around a vertical rotation axis on the base part, and a holding part disposed in the rotating part, and having a holding area in which the mobile terminal is held.

To solve the above-described problem, the device for monitoring a dangerous situation in a space based on a frequency response pattern according to an embodiment of the present disclosure and the method for monitoring a dangerous situation in a space using the same may generate a preset frequency through the speaker using the mobile terminal possessed by the user, receive the frequency reflected in the space at the microphone and determine whether the dangerous situation occurred in the space with high accuracy by analyzing the frequency response pattern, in order to respond to the dangerous situation quickly.

Since an embodiment of the present disclosure makes use of mobile terminals possessed by most of the people in recent years, it is possible to minimize the cost of constructing the entire system, and since the construction process is very straightforward, it is possible to allow the user to easily apply the system at home without expert knowledge.

The effects of the present disclosure are not limited to the above-described effects, and another effect will be clearly understood by those skilled in the art from the appended claims.

### BRIEF DESCRIPTION OF THE DRAWINGS

FIG. 1 is a diagram showing a device for monitoring a dangerous situation in a space according to an embodiment of the present disclosure.

FIG. 2 is a diagram showing each step of a method for monitoring a dangerous situation in a space according to an embodiment of the present disclosure.

FIG. 3 is a diagram showing various operational modes in a method for monitoring a dangerous situation in a space according to an embodiment of the present disclosure.

FIG. 4 is a schematic diagram showing the flow of communication through a device for monitoring a dangerous situation in a space according to an embodiment of the present disclosure.

FIG. 5 is a diagram detailing the step (e) performed in an intrusion situation in a method for monitoring a dangerous situation in a space according to an embodiment of the present disclosure.

FIG. 6 is a diagram detailing the step (e) performed in a fire situation in a method for monitoring a dangerous situation in a space according to an embodiment of the present disclosure.

FIG. 7 is a diagram showing an additional step that may be performed before the step (a) in a method for monitoring a dangerous situation in a space according to an embodiment of the present disclosure.

### DETAILED DESCRIPTION

Hereinafter, an exemplary embodiment of the present disclosure for realizing the objective of the present disclosure will be described with reference to the accompanying drawings. In describing this embodiment, the same name and reference signal is used for the same element and its detailed description is omitted.

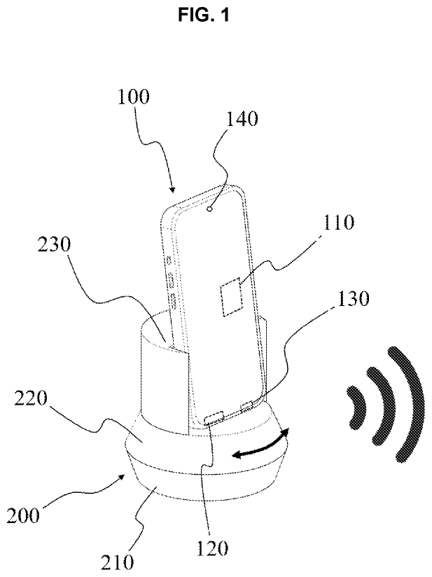

FIG. 1 is a diagram showing a device for monitoring a dangerous situation in a space according to an embodiment of the present disclosure.

As shown in FIG. 1, the device for monitoring a dangerous situation in a space according to an embodiment of the present disclosure includes a mobile terminal 100 installed in the arbitrary space, and may further include a holder unit 200 to hold the mobile terminal 100.

Additionally, in this embodiment, specifically, the mobile terminal 100 includes a speaker 120, a microphone 130, a camera 140 and a processing unit 110.

The speaker 120 plays a role in generating a frequency corresponding to an operational mode selected through control software installed on the mobile terminal 100, and the microphone 130 plays a role in receiving the frequency that was generated by the speaker 120 and reflected in the space.

Additionally, the camera 140 acquires image data in the space in which the mobile terminal 100 is installed, and the processing unit 110 loads a setting value corresponding to the operational mode selected through the control software, and determines whether a dangerous situation occurred in the corresponding space by comparing the frequency response pattern received by the microphone 130 with a preset reference value. When it is determined that the dangerous situation occurred in the space, the processing unit 110 takes a follow-up action.

Its algorithm will be described in detail.

The holder unit 200 is configured to hold the mobile terminal 100, and includes a base part 210 to provide support, a rotating part 220 which rotatably operates around the vertical rotation axis on the base part 210, and a holding part 230 disposed in the rotating part 220 and having a holding area in which the mobile terminal 100 is held.

That is, the holder unit 200 stably holds the mobile terminal 100 at an arbitrary angle to the ground, and especially since the holder unit 200 includes the rotating part 220 that is rotatable, it is possible to easily acquire the image data of the entire corresponding space through the camera 140 of the mobile terminal 100.

Although not shown, the holder unit 200 may further include a tilting part which tiltably operates with respect to the horizontal rotation axis together with the rotating part 220, and accordingly, it is possible to arbitrarily change the angle at which the mobile terminal 100 is held.

Hereinafter, a method for monitoring a dangerous situation in a space, performed through the device for monitoring a dangerous situation in a space according to an embodiment of the present disclosure, will be described in detail.

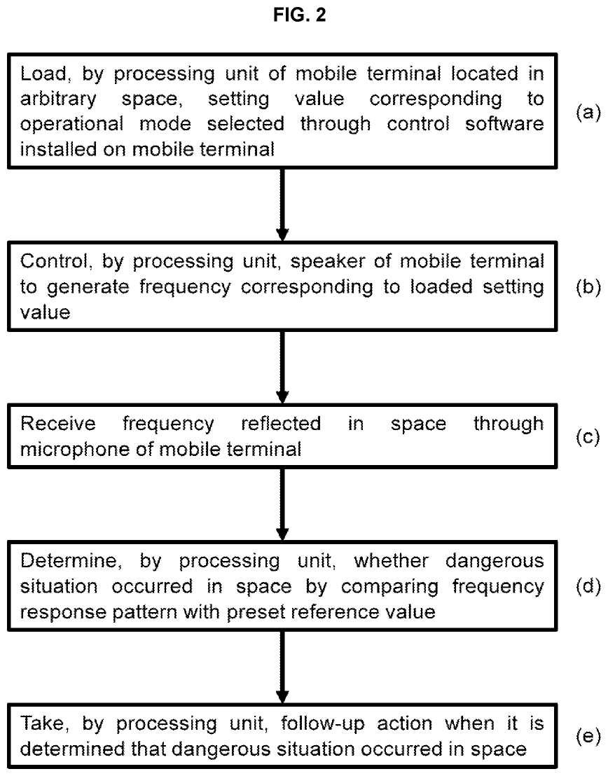

FIG. 2 is a diagram showing each step of the method for monitoring a dangerous situation in a space according to an embodiment of the present disclosure.

As shown in FIG. 2, the method for monitoring a dangerous situation in a space according to an embodiment of the present disclosure may basically include the steps (a) to (e).

First, in the step (a), the processing unit 110 of the mobile terminal 100 located in the arbitrary space loads the setting value corresponding to the operational mode selected through the control software installed on the mobile terminal 100.

The operational mode may include a plurality of sub-modes that may be arbitrarily changed depending on the time, place and the user's lifestyle pattern, and the sub-modes may have different setting values.

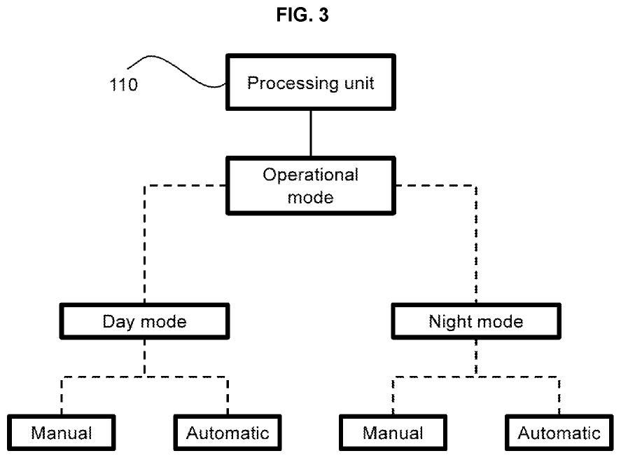

FIG. 3 is a diagram showing various operational modes in the method for monitoring a dangerous situation in a space according to an embodiment of the present disclosure.

As shown in FIG. 3, in this embodiment, the operational mode that may be selected by the processing unit 110 may include a day mode and a night mode, and each sub-mode may be controlled in any one of a manual mode in which the user inputs a command to load the setting value in person and an automatic mode in which the processing unit 110 automatically loads the setting value through an artificial intelligence algorithm.

Additionally, the day mode is a mode having a day setting value special for the day, and may be set to generate inaudible frequency when a registered user is present in the space and audible frequency when there is no registered user in the space.

For example, when the user is absent from the space during the day, the degree of freedom in sound intensity is high, so audible frequency may be generated to ensure the maximum signal sensitivity that will be processed, and when the user is present in the space, inaudible frequency that is unrecognizable to the user may be generated not to cause any inconvenience in life.

Additionally, the night mode is a mode having a night setting value special for the night, and may be set to generate inaudible frequency irrespective of the presence or absence of the user.

After the step (a) is performed, each of the step (b) of controlling, by the processing unit 110, the speaker 120 of the mobile terminal 100 to generate the frequency corresponding to the loaded setting value, and the step (c) receiving the frequency that was generated in the step (b) and reflected in the space through the microphone 130 of the mobile terminal 100 may be performed.

Subsequently, in the step (d), the processing unit 110 determines whether the dangerous situation occurred in the space by comparing the frequency response pattern with the preset reference value, and in the step (e), when it is determined that the dangerous situation occurred in the space by the step (d), the processing unit 110 takes the follow-up action.

Specifically, in this embodiment, the step (d) may include determining, by the processing unit 110, whether any one dangerous situation of an intrusion situation or a fire situation occurred by comparing the frequency response pattern with the preset reference value.

The intrusion situation or the fire situation may be identified by comparing the frequency response characteristics at a preset time interval of, for example, 3 sec, representing the spectrum of each data and analyzing the changing trend in the spectrum.

Additionally, according to the result of determining which of the intrusion situation and the fire situation occurred, the processing unit 110 may take the corresponding follow-up action.

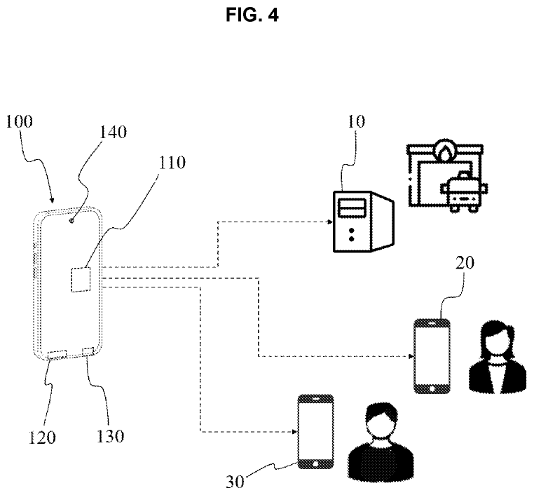

FIG. 4 is a schematic diagram showing the flow of communication through the device for monitoring a dangerous situation in a space according to an embodiment of the present disclosure.

As shown in FIG. 4, when any one of the intrusion situation or the fire situation occurred, the processing unit 110 may provide an alarm to a preset external terminal, for example, a management server 10 of an emergency response agency such as a fire station, a personal terminal 20 possessed by an employee such as a social worker/a welfare worker and a personal terminal 30 possessed by a guardian.

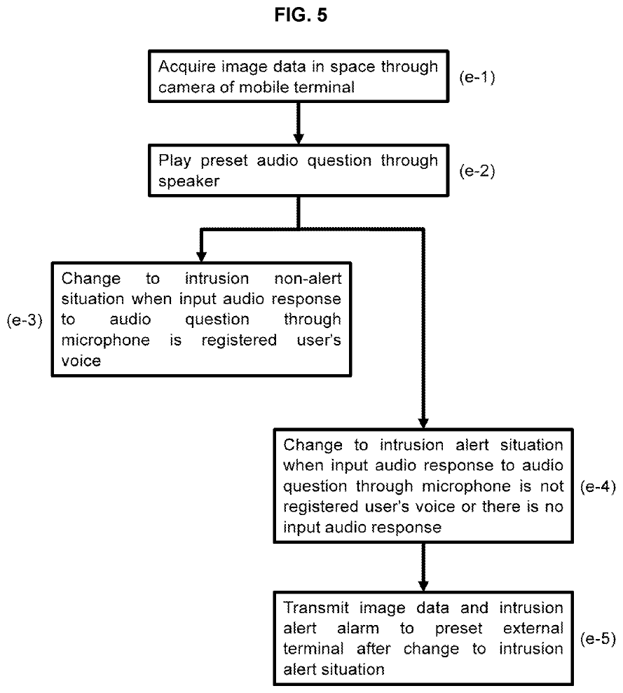

More specifically, FIG. 5 is a diagram detailing the step (e) performed in the intrusion situation in the method for monitoring a dangerous situation in a space according to an embodiment of the present disclosure.

As shown in FIG. 5, when the processing unit 110 determines the intrusion situation in the step (d), first, the step (e-1) of acquiring image data in the space through the camera 140 of the mobile terminal 100 may be performed.

Subsequently, the step (e-2) includes playing a preset audio question through the speaker 120 and waiting for an input audio response. For example, the processing unit 110 may perform control to play the audio question such as ‘Please verify intrusion’ through the speaker 120, and waits for the input audio response to the question.

Additionally, according to the audio response input result, any one of the steps (e-3) and (e-4) may be selectively performed.

The step (e-3) is performed when the input audio response to the audio question through the microphone 130 is the registered user's voice, and the processing unit 110 changes the current situation to an intrusion non-alert situation to cancel the alert.

Additionally, in the step (e-4), the current situation is changed to an intrusion alert situation when the input audio response to the audio question through the microphone 130 is not the registered user's voice or there is no input audio response.

After the change to the intrusion alert situation by the step (e-4), the step (e-5) of transmitting an arbitrarily set intrusion alert alarm to the preset external terminal together with the image data acquired in the step (e-1) is performed.

That is, through the step (e-5), the processing unit 110 may transmit the image data and the intrusion alert alarm to the management server 10 of the emergency response agency such as a fire station, the personal terminal 20 possessed by the employee such as a social worker/a welfare worker and the personal terminal 30 possessed by the guardian, in order to respond to the dangerous situation quickly.

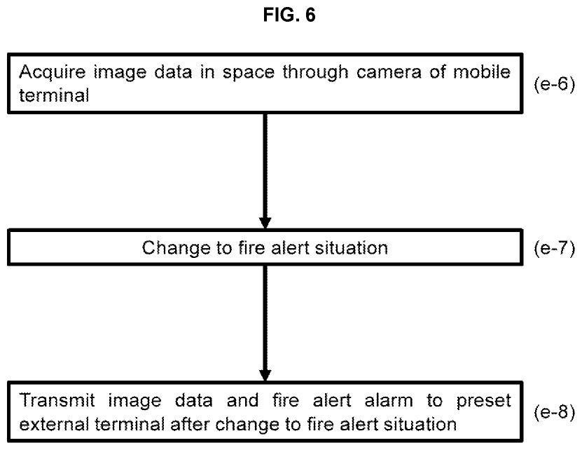

FIG. 6 is a diagram detailing the step (e) performed in the fire situation in the method for monitoring a dangerous situation in a space according to an embodiment of the present disclosure.

As shown in FIG. 6, when the processing unit 110 determines the fire situation in the step (d), each of the step (e-6) of acquiring image data in the space through the camera 140 of the mobile terminal 100, the step (e-7) of changing, by the processing unit 110, to a fire alert situation, and after the change to the fire alert situation by the step (e-7), the step (e-8) of transmitting the image data acquired through the step (e-6) and an arbitrarily set fire alert alarm to the preset external terminal may be performed.

That is, in case that a fire occurs, there is a low possibility that there may be an exceptional situation, so any verification process is omitted and the current situation is immediately changed to the fire alert situation and the image data and the fire alert alarm are transmitted to the external terminal to make rapid response to put out the fire.

According to each of the above-described steps, the dangerous situation is determined through the frequency response pattern generated through the speaker 120, and to respond to the dangerous situation, the image data is acquired through the camera 140 and transmitted with the alarm, but on the contrary, the present disclosure may perform a pre-detection step through the camera 140 first.

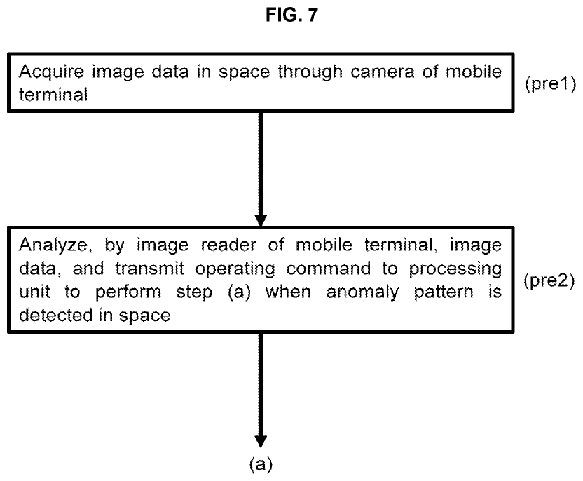

FIG. 7 is a diagram showing an additional step that may be performed before the step (a) in the method for monitoring a dangerous situation in a space according to an embodiment of the present disclosure.

As shown in FIG. 7, in this embodiment, before the step (a), the method may further include (pre1) acquiring image data in the space through the camera 140 of the mobile terminal 100, and (pre2) analyzing, by an image reader of the mobile terminal 100, the image data, and when an anomaly pattern is detected in the space, transmitting an operating command to the processing unit 110 to perform the step (a).

That is, when the above step is further included, it is possible to detect the anomaly pattern through the image data acquired through the camera 140, and actively select the setting value in the subsequent step (a).

The exemplary embodiment of the present disclosure has been hereinabove described, and it is obvious to those skilled in the art that the present disclosure may be embodied in any other form without departing from the spirit and scope of the present disclosure. Therefore, the above-described embodiment is provided by way of illustration, but not intended to limit the present disclosure, and accordingly, the present disclosure is not limited to the above-described embodiment and may be modified within the scope of the appended claims and equivalents thereof.

What is claimed is:

1. A method for monitoring a dangerous situation in a space based on a frequency response pattern, the method comprising:
loading, by a processing unit of a mobile terminal located in the arbitrary space, a setting value corresponding to an operational mode selected through control software installed on the mobile terminal;
controlling, by the processing unit, a speaker of the mobile terminal to generate a frequency corresponding to the loaded setting value;
receiving the frequency which was generated in the controlling and reflected in the space through a microphone of the mobile terminal;
determining, by the processing unit, whether the dangerous situation occurred in the space by comparing the frequency response pattern with a preset reference value; and
taking, by the processing unit, a follow-up action when it is determined that the dangerous situation occurred in the space by the determining.

2. The method of claim 1, further comprising, before the loading:
acquiring image data in the space through a camera of the mobile terminal; and
analyzing, by an image reader of the mobile terminal, the image data, and transmitting an operating command to the processing unit to perform the loading when an anomaly pattern is detected in the space.

3. The method of claim 1, wherein the operational mode includes a day mode having a day setting value special for day and a night mode having a night setting value special for night.

4. The method of claim 3, wherein the day setting value is set to generate an inaudible frequency when a registered user is present in the space and an audible frequency when there is no registered user in the space; and
the night setting value is set to generate the inaudible frequency.

5. The method of claim 1, wherein the determining comprises determining, by the processing unit, whether any one dangerous situation of an intrusion situation or a fire situation occurred by comparing the frequency response pattern with the preset reference value.

6. The method of claim 5, wherein, when, in the determining, the processing unit determines the intrusion situation, the taking of the follow-up action comprises:
acquiring image data in the space through the camera of the mobile terminal;
playing a preset audio question through the speaker;
changing to an intrusion non-alert situation when an input audio response to the audio question through the microphone is a registered user's voice;
changing to an intrusion alert situation when the input audio response to the audio question through the microphone is not the registered user's voice or there is no input audio response; and
transmitting the image data and an intrusion alert alarm to a preset external terminal after the change to the intrusion alert situation by the changing to the intrusion alert situation.

7. The method of claim 5, wherein, when, in the determining, the processing unit determines the fire situation, the taking of the follow-up action comprises:
acquiring image data in the space through the camera of the mobile terminal;
changing to a fire alert situation; and
transmitting the image data and a fire alert alarm to a preset external terminal after the change to the fire alert situation by the changing to the fire alert situation.

8. A device for monitoring a dangerous situation in a space based on a frequency response pattern, the device comprising:
a mobile terminal installed in the space, the mobile terminal comprising:
a speaker to generate a frequency corresponding to an operational mode selected through control software installed on the mobile terminal;
a microphone to receive the frequency which was generated by the speaker and reflected in the space; and
a processing unit to load a setting value corresponding to the operational mode, determine whether the dangerous situation occurred in the space by comparing the frequency response pattern received by the microphone with a preset reference value, and take a follow-up action when it is determined that the dangerous situation occurred in the space.

9. The device of claim 8, wherein the mobile terminal further comprises a camera to acquire image data in the space.

10. The device of claim 8, further comprising:
a holder unit to hold the mobile terminal.

11. The device of claim 9, wherein the holder unit includes:
a base part;
a rotating part configured to rotatably operate around a vertical rotation axis on the base part; and
a holding part disposed in the rotating part, the holding part having a holding area in which the mobile terminal is held.
